(19) United States
(12) Patent Application Publication
(10) Pub. No.: US 2024/0405495 A1
(43) Pub. Date: Dec. 5, 2024

(54) Cable Unwinding Device and Cable Unwinding Method

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 18/734,357

(22) Filed: Jun. 5, 2024

(30) Foreign Application Priority Data
Jun. 5, 2023 (CN) 202310655669.3

(51) Int. Cl. H01R 43/28; B21F 7/00

(52) U.S. Cl. CPC H01R 43/28; B21F 7/00

(57) ABSTRACT

A cable unwinding device includes a cable clamp for clamping and fixing a cable, a core ware clamp for clamping two twisted core wires of the cable, a rotating device, and a translation device. The rotating device drives the core wire clamp to rotate around the central axis of the cable. The translation device drives the core wire clamp to move in a first horizontal direction parallel to the central axis of the cable. As the rotating device drives the core wire clamp to rotate around the central axis of the cable, the translation device drives the core wire clamp to move along the first horizontal direction, such that the two twisted core wires are untwisted and straightened.

### CROSS-REFERENCE TO RELATED APPLICATION

This application claims the benefit of Chinese Patent Application No. CN202310655669.3 filed on Jun. 5, 2023, in the State Intellectual Property Office of China, the whole disclosure of which is incorporated herein by reference.

### FIELD OF THE INVENTION

Embodiments of the present disclosure relate to a cable unwinding device and a cable unwinding method.

### BACKGROUND

In the prior art, a twisted pair cable includes two twisted core wires. It is often necessary to crimp terminals on the two core wires of the twisted pair cable. To conveniently crimp terminals on two core wires, it is necessary to first untwist and straighten the two core wires. In the prior art, only manual methods can be used to unwind and straighten the two core wires, which leads to very low efficiency.

### SUMMARY

According to an embodiment of the present disclosure, a cable unwinding device includes a cable clamp for clamping and fixing a cable, a core ware clamp for clamping two twisted core wires of the cable, a rotating device, and a translation device. The rotating device drives the core wire clamp to rotate around the central axis of the cable. The translation device drives the core wire clamp to move in a first horizontal direction parallel to the central axis of the cable. As the rotating device drives the core wire clamp to rotate around the central axis of the cable, the translation device drives the core wire clamp to move along the first horizontal direction, such that the two twisted core wires are untwisted and straightened.

### BRIEF DESCRIPTION OF THE DRAWINGS

The invention will now be described by way of example with reference to the accompanying Figures, of which:

FIG. 1 shows an illustrative perspective view of a cable according to an exemplary embodiment of the present invention, wherein the two core wires of the cable have not yet been untwisted and straightened;

FIG. 2 shows an illustrative perspective view of a cable according to an exemplary embodiment of the present invention, where the two core wires of the cable have been untwisted and straightened;

FIG. 3 shows an illustrative perspective view of a cable unwinding device according to an exemplary embodiment of the present invention when viewed from one side;

FIG. 4 shows an illustrative perspective view of a cable unwinding device according to an exemplary embodiment of the present invention when viewed from the other side;

FIG. 5 shows an illustrative perspective view of a translation device of a cable unwinding device according to an exemplary embodiment of the present invention;

FIG. 6 shows an illustrative perspective view of a rotating device of a cable unwinding device according to an exemplary embodiment of the present invention;

FIG. 7 shows an illustrative perspective view of the rotating device and core wire clamp of the cable unwinding device according to an exemplary embodiment of the present invention;

FIG. 8 shows an illustrative perspective view of the core wire clamp of a cable unwinding device according to an exemplary embodiment of the present invention;

FIG. 9 shows an illustrative local enlarged view of the core wire clamp of a cable unwinding device according to an exemplary embodiment of the present invention; and

FIG. 10 shows an illustrative view of unwinding and straightening two core wires of a twisted cable according to an exemplary embodiment of the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth to provide a thorough understanding of the disclosed embodiments. It will be apparent, however, that one or more embodiments may be practiced without these specific details. In other instances, well-known structures and devices are schematically shown to simplify the drawing.

A cable unwinding device according to an embodiment of the present disclosure includes: a cable clamp for clamping and fixing a cable; a core wire clamp for clamping two twisted core wires of the cable; a rotating device for driving the core wire clamp to rotate around the central axis of the cable; and a translation device for driving the core wire clamp to move in a first horizontal direction parallel to the central axis of the cable. While the rotating device drives the core wire clamp to rotate around the central axis of the cable, the translation device drives the core wire clamp to move along the first horizontal direction, such that the two twisted core wires are untwisted and straightened.

According to another embodiment, a cable untwisting method comprises the steps of: providing the above cable untwisting device; using the cable clamp to clamp and fix the cable; clamping the roots of two exposed core wires at one end of the cable with the core wire clamp; and using the rotating device to drive the core wire clamp to rotate around the central axis of the cable, while using a translation device to drive the core wire clamp to move towards the ends of the two core wires along the axial direction of the cable.

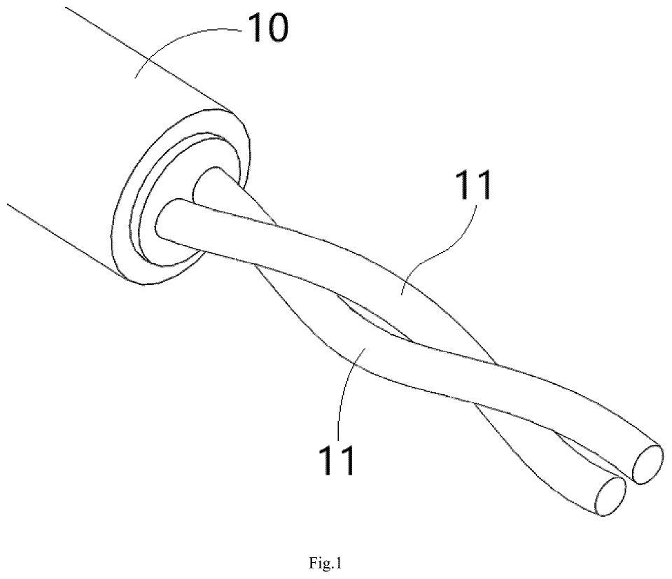

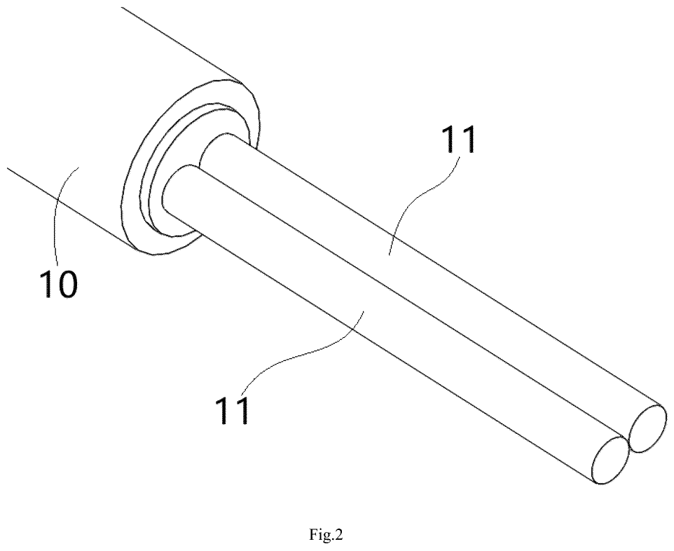

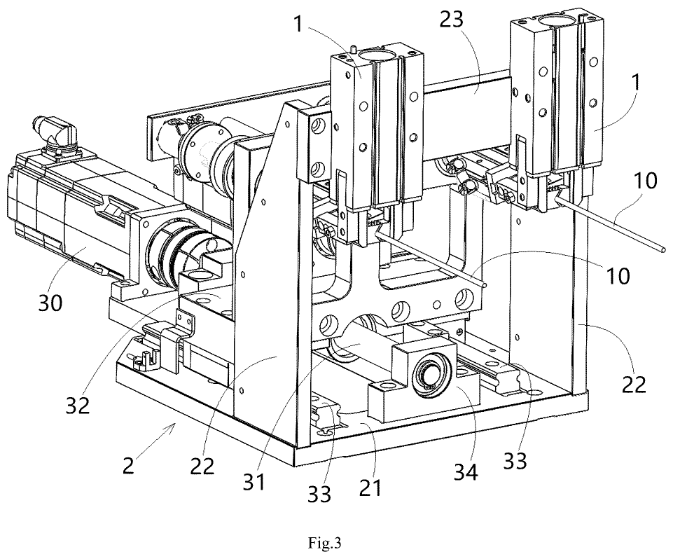

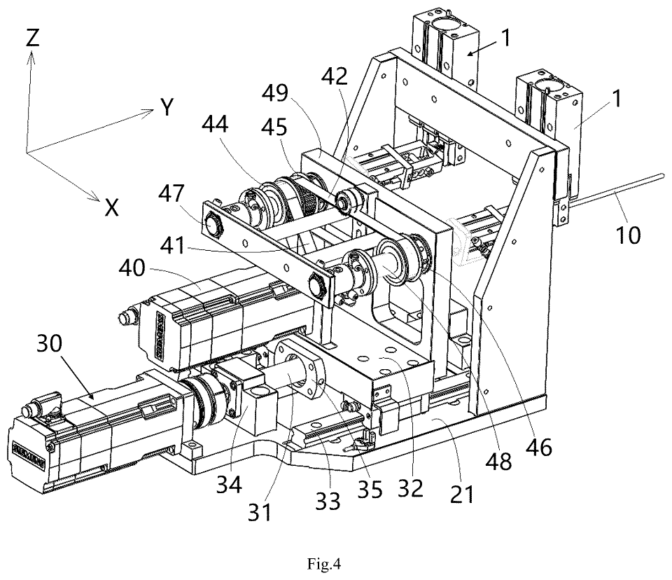

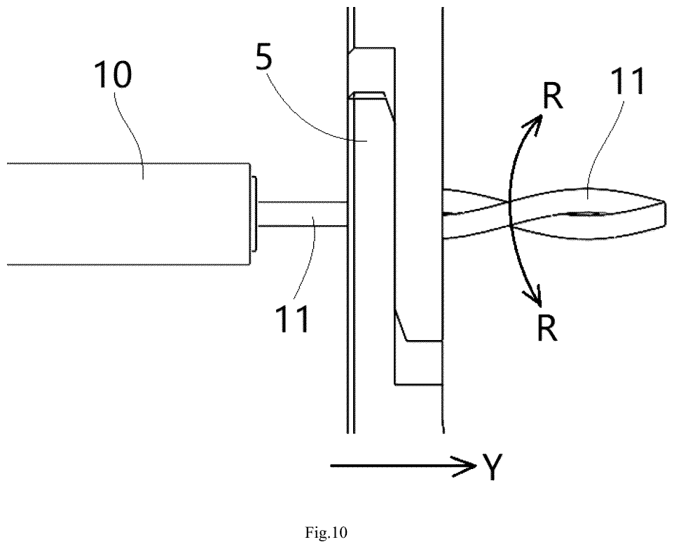

FIG. 1 shows an illustrative perspective view of a cable 10 according to an exemplary embodiment of the present invention, wherein two core wires 11 of the cable 10 have not yet been untwisted and straightened. FIG. 2 shows an illustrative perspective view of the cable 10 according to an exemplary embodiment of the present disclosure, where the two core wires 11 of the cable 10 have been untwisted and straightened. FIG. 3 shows an illustrative perspective view of a cable unwinding device according to an exemplary embodiment of the present disclosure when viewed from one side. FIG. 4 shows an illustrative perspective view of a cable unwinding device according to an exemplary embodiment of the present disclosure when viewed from the other side. FIG. 10 shows an illustrative view of untwisting and straightening the two core wires 11 of the twisted pair of the cable 10 according to an exemplary embodiment of the present disclosure.

As shown in FIGS. 1-4 and 10, in an exemplary embodiment of the present disclosure, a cable untwisting device is disclosed. The cable unwinding device mainly includes a cable clamp 1, a core wire clamp 5, a rotating device 4, and a translation device 3. The cable clamp 1 is used to clamp and secure the cable 10. The core wire clamp 5 is used to clamp the two twisted core wires 11 of the cable 10. The rotating device 4 is used to drive the core wire clamp 5 to rotate around the central axis of the cable 10, that is, around the arrow R in FIG. 10. The translation device 3 is used to drive the core wire clamp 5 to move in the first horizontal direction Y parallel to the central axis of the cable 10.

While the rotating device 4 drives the core wire clamp 5 to rotate around the central axis of the cable 10, the translation device 3 drives the core wire clamp 5 to move in the first horizontal direction Y, so that the two twisted core wires 11 are untwisted and straightened. The rotating device 4 is installed on the translation device 3, so that the rotating device 4 can be moved along the first horizontal direction Y with the translation device 3.

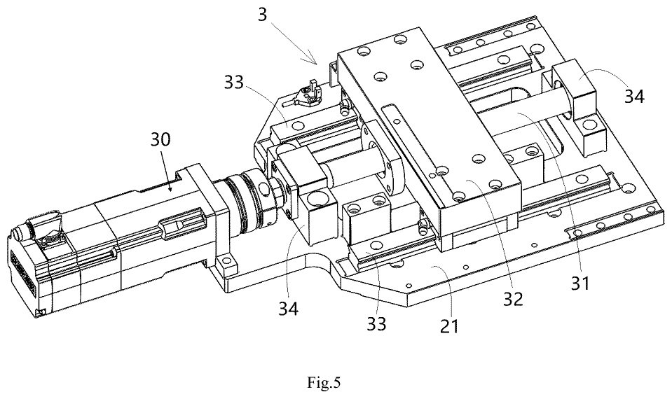

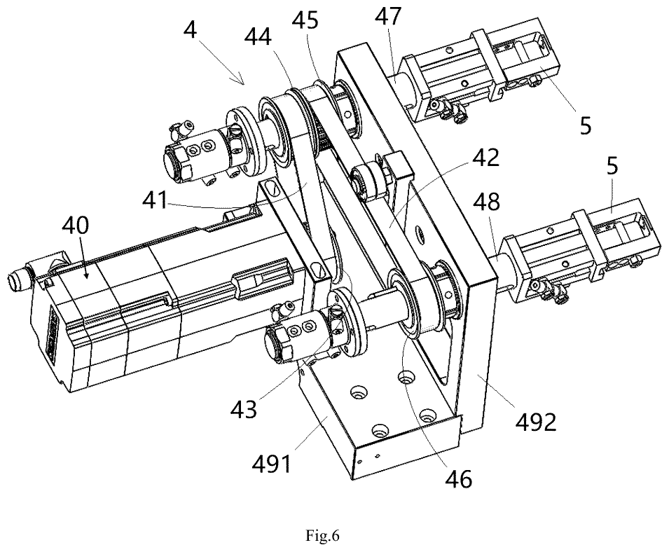

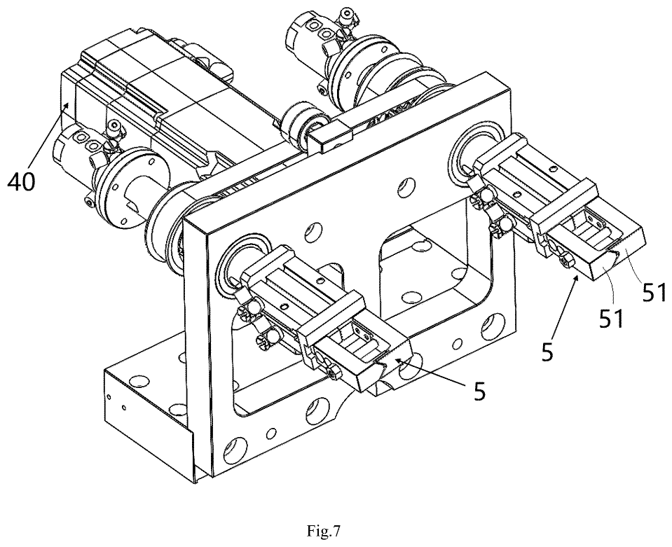

FIG. 5 shows an illustrative perspective view of the translation device 3 of the cable unwinding device according to an exemplary embodiment of the present invention. FIG. 6 shows an illustrative perspective view of the rotating device 4 of the cable unwinding device according to an exemplary embodiment of the present invention. FIG. 7 shows an illustrative perspective view of the rotating device 4 and the core wire clamp 5 of the cable unwinding device according to an exemplary embodiment of the present invention.

As shown in FIGS. 1-7 and 10, in the illustrated embodiments, the cable unwinding device further comprises a frame 2, which includes a fixed seat 21. The translation device 3 includes a guide rail 33, a movable seat 32, and a first driving device. The guide rail 33 is installed on the fixed seat 21 and extends along the first horizontal direction Y. The movable seat 32 is slidably installed on the guide rail 33 to be able to move along the guide rail 33. The first driving device is installed on the fixed seat 21 to drive the movable seat 32 to move along the guide rail 33.

The first driving device comprises a nut 35, a screw rod 31, and a first motor 30. The nut 35 is fixed to the movable seat 32. The screw rod 31 is rotatably installed on the fixed seat 21 and threaded to the nut 35. The first motor 30 is installed on the fixed seat 21, and its output shaft is connected to one end of the screw rod 31. The first motor 30 is used to drive the screw rod 31 to rotate, so as to drive the movable seat 32 to move along the guide rail 33 through the nut 35. In the illustrated embodiment, the first motor 30 can be a servo motor, which can improve control accuracy.

A pair of support seats 34 are installed on the fixed seat 21. The two ends of the screw rod 31 are respectively rotatably installed on the pair of support seats 34.

In the illustrated embodiments, the frame 2 further comprises a pair of vertical brackets 22 and a crossbeam 23. The pair of vertical brackets 22 are fixed to the fixed seat 21. The crossbeam 23 is connected between the pair of vertical brackets 22. The cable clamp 1 is fixed to the crossbeam 23.

The cable unwinding device comprises two cable clamps 1 for clamping and fixing two cables 10, respectively. The cable unwinding device includes two core wire clamps 5, which are used to respectively clamp the core wires 11 of two of the cables 10. The rotating device 4 is installed on the movable seat 32 and is suitable for driving two core wire clamps 5 to rotate simultaneously, so that the core wires 11 of the two cables 10 are simultaneously untwisted and straightened. This can improve the efficiency of cable untwisting and straightening.

The rotating device 4 includes an installation bracket 49, a first rotating shaft 47, a second rotating shaft 48, and a second driving device. The installation bracket 49 is fixed to the movable seat 32. The first shaft 47 is rotatably installed on the installation bracket 49. The second shaft 48 is rotatably installed onto the installation bracket 49. The second driving device is installed on the movable seat 32 to drive the first shaft 47 and the second shaft 48 to rotate synchronously. The first shaft 47 and the second shaft 48 are axially connected to the two core wire clamps 5, respectively, to drive the two core wire clamps 5 to rotate synchronously. The axes of the first shaft 47 and the second shaft 48 are parallel to the first horizontal direction Y. The first shaft 47 and the second shaft 48 are spaced from each other at a predetermined distance in a second horizontal direction X perpendicular to the first horizontal direction Y.

The second driving device comprises a second motor 40, a first pulley 43, a second pulley 44, a third pulley 45, a fourth pulley 46, a first transmission belt 41, and a second transmission belt 42. The second motor 40 is installed onto the movable seat 32. The first pulley 43 is fixed to the output shaft of the second motor 40. The second pulley 44 is fixed to the first shaft 47. The third pulley 45 is fixed to the first shaft 47. The fourth pulley 46 is fixed to the second shaft 48. The first transmission belt 41 is connected between the first pulley 43 and the second pulley 44. The second transmission belt 42 is connected between the third pulley 45 and the fourth pulley 46.

The installation bracket 49 comprises a base 491 and a vertical installation plate 492. The base 491 is fixed to the movable seat 32. The vertical installation plate 492 is fixed to the base 491. The first shaft 47 and the second shaft 48 are rotatably installed on the vertical installation plate 492.

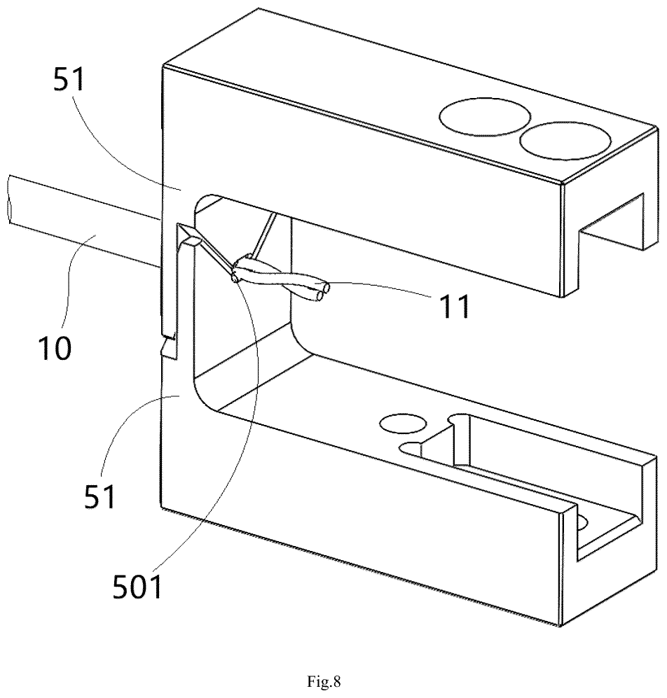

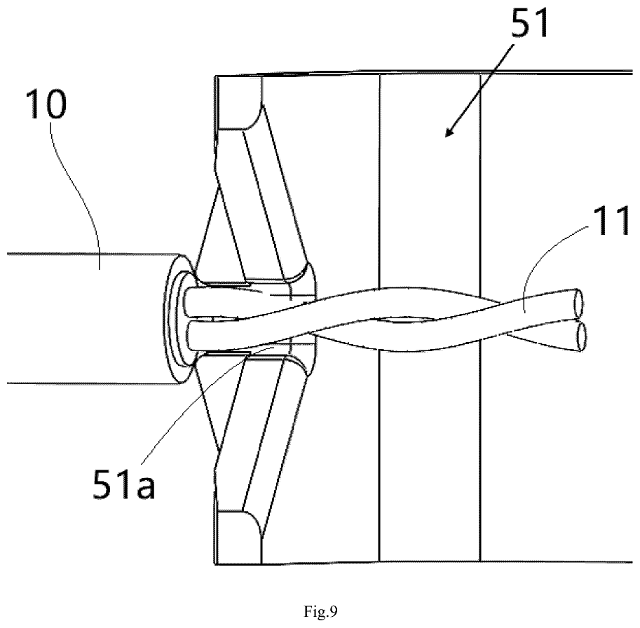

FIG. 8 shows an illustrative perspective view of the core wire clamp 5 of the cable unwinding device according to an exemplary embodiment of the present invention. FIG. 9 shows a partially enlarged schematic diagram of the core wire clamp 5 of the cable unwinding device according to an exemplary embodiment of the present invention.

As shown in FIGS. 1 to 10, the core wire clamp 5 includes a pair of clamping parts 51, and a slot 51a is formed on the clamping part. The two core wires 11 of the cable 10 are clamped in the slots 51a of the pair of clamping parts 51. When the pair of clamping parts 51 clamps the two core wires 11 of cable 10, the slots 51a on the pair of clamping parts 51 are combined to form a slot hole 501, and the cross-section of the slot hole 501 is elliptical.

As shown in FIGS. 1 to 10, in another exemplary embodiment of the present disclosure, there is also disclosed a cable untwisting method, which mainly comprises the following steps:
S10: providing the above cable untwisting device;
S20: using the cable clamp 1 to clamp and fix the cable 10;
S30: clamping the roots of two exposed core wires 11 at one end of the cable 10 with the core wire clamp 5; and
S40: using the rotating device 4 to drive the core wire clamp 5 to rotate around the central axis of the cable 10, while using a translation device 3 to drive the core wire clamp 5 to move towards the ends of the two core wires 11 along the axial direction of the cable 10.

In addition, those areas in which it is believed that those of ordinary skill in the art are familiar, have not been described herein in order not to unnecessarily obscure the invention described. Accordingly, it must be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cable unwinding device, comprising:
a cable clamp clamping and fixing a cable;
a core wire clamp clamping two twisted core wires of the cable;
a rotating device driving the core wire clamp to rotate around the central axis of the cable; and
a translation device driving the core wire clamp to move in a first horizontal direction parallel to the central axis of the cable, wherein while the rotating device drives the core wire clamp to rotate around the central axis of the cable, the translation device drives the core wire clamp to move along the first horizontal direction, so that the two twisted core wires are untwisted and straightened.

2. The cable unwinding device according to claim 1, wherein the rotating device is installed on the translation device such that the rotating device can be moved along the first horizontal direction with the translation device.

3. The cable unwinding device according to claim 2, further comprising a frame including a fixed seat, wherein the translation device comprises:
a guide rail which is installed on the fixed seat and extends along the first horizontal direction;
a movable seat which is slidably installed on the guide rail to be able to move along the guide rail; and
a first driving device which is installed on the fixed seat to drive the movable seat to move along the guide rail.

4. The cable unwinding device according to claim 3, wherein the first driving device comprises:
a nut fixed to the movable seat;
a screw rod rotatably installed on the fixed seat and threaded to the nut; and
a first motor installed on the fixed seat.

5. The cable unwinding device according to claim 4, wherein an output shaft of the first motor is connected to one end of the screw rod, the first motor is used to drive the screw rod to rotate, so as to drive the movable seat to move along the guide rail through the nut.

6. The cable unwinding device according to claim 5, wherein a pair of support seats are installed on the fixed seat, and the two ends of the screw rod are rotatably installed on the pair of support seats, respectively.

7. The cable unwinding device according to claim 6, wherein the frame further comprises:
a pair of vertical brackets fixed to the fixed seat; and
a crossbeam which is connected between the pair of vertical brackets, the cable clamp is fixed to the crossbeam.

8. A cable unwinding device according to claim 7, wherein the cable unwinding device comprises two cable clamps for respectively clamping and fixing two cables.

9. A cable unwinding device according to claim 8, wherein the cable unwinding device comprises two core wire clamps for clamping the core wires of two cables, respectively.

10. A cable unwinding device according to claim 9, wherein the rotating device is installed on the movable seat and is suitable for driving the two core wire clamps to rotate simultaneously such that the core wires of the two cables are simultaneously untwisted.

11. The cable unwinding device according to claim 10, wherein the rotating device comprises:
an installation bracket fixed to the movable seat;
a first shaft which is rotatably installed on the installation bracket;
a second shaft which is rotatably installed on the installation bracket; and
a second driving device which is installed on the movable seat for driving the first shaft and the second shaft to rotate synchronously.

12. The cable unwinding device according to claim 11, wherein the first shaft and the second shaft are respectively axially connected to the two core wire clamps to drive the two core wire clamps to rotate synchronously.

13. The cable unwinding device according to claim 12, wherein the axis of the first shaft and the second shaft is parallel to the first horizontal direction, and the first shaft and the second shaft are spaced from each other at a predetermined distance in a second horizontal direction perpendicular to the first horizontal direction.

14. The cable unwinding device according to claim 12, wherein the second driving device comprises:
a second motor installed on the movable seat;
a first pulley fixed to the output shaft of the second motor;
a second pulley fixed to the first shaft; and
a first transmission belt connected between the first pulley and the second pulley.

15. The cable unwinding device according to claim 14, wherein the second driving device further comprises:
a third pulley fixed to the first shaft;
a fourth pulley fixed to the second shaft; and
a second transmission belt connected between the third pulley and the fourth pulley.

16. The cable unwinding device according to claim 11, wherein the installation bracket comprises:
a base fixed to the movable seat; and
a vertical installation plate fixed to the base.

17. The cable unwinding device according to claim 16, wherein the first shaft and the second shaft are rotatably installed on the vertical installation plate.

18. The cable unwinding device according to claim 1, wherein the core wire clamp comprises a pair of clamping parts, and a slot is formed on the clamping part, the two core wires of the cable are clamped in the slots of the pair of clamping parts.

19. The cable unwinding device according to claim 18, wherein when the pair of clamping parts clamp two core wires of the cable, the slots on the pair of clamping parts are combined into a slot hole, and the cross-section of the slot hole is elliptical.

20. A cable untwisting method, comprising the following steps of:
S10: providing the cable untwisting device, including:
a cable clamp clamping and fixing a cable;
a core wire clamp clamping two twisted core wires of the cable;
a rotating device driving the core wire clamp to rotate around the central axis of the cable; and
a translation device driving the core wire clamp to move in a first horizontal direction parallel to the central axis of the cable, wherein while the rotating device drives the core wire clamp to rotate around the central axis of the cable, the translation device drives the core wire clamp to move along the first horizontal direction, so that the two twisted core wires are untwisted and straightened;
S20: using the cable clamp to clamp and fix the cable;
S30: clamping the roots of two exposed core wires at one end of the cable with the core wire clamp; and
S40: using the rotating device to drive the core wire clamp to rotate around the central axis of the cable, while using a translation device to drive the core wire clamp to move towards the ends of the two core wires along the axial direction of the cable.
